(19) United States
(12) Patent Application Publication
(10) Pub. No.: US 2024/0259085 A1
(43) Pub. Date: Aug. 1, 2024

(54) COVERAGE DATA TRANSFER FOR COMMUNICATIONS WITH A NON-TERRESTRIAL NETWORK NODE

(71) Applicant: Apple Inc., Cupertino, CA (US)

(72) Inventors: Vivek G. Gupta, San Jose, CA (US); Haijing Hu, Los Gatos, CA (US); Sridhar Prakasam, Fremont, CA (US)

(73) Assignee: Apple Inc., Cupertino, CA (US)

(21) Appl. No.: 18/395,079

(22) Filed: Dec. 22, 2023

Related U.S. Application Data
(60) Provisional application No. 63/442,404, filed on Jan. 31, 2023.

(51) Int. Cl. H04B 7/185

(52) U.S. Cl. CPC H04B 7/18513

(57) ABSTRACT

The present application relates to devices and components including apparatus, systems, and methods that support discontinuous network coverage. In an example, a UE and a network exchange information indicating a capability for using a control plane, a user plane, a short message service, and/or an operation and maintenance server for the transfer of coverage data of a non-terrestrial network indicating when and/or where non terrestrial network coverage can be available to the UE. Based on this information, the coverage data is provisioned on the UE and in the access and mobility function (AMF) in the network. Thereafter, the UE can determine when the UE is in the coverage area of the non-terrestrial network and can connect to a network node thereof, such as a base station.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more. Cellular coverage is a relevant feature for data transmission. In particular, when a user equipment (UE) is within a cell coverage, the UE may be able to exchange data with the cellular network. Otherwise, the UE may not be able to do so.

### BRIEF DESCRIPTION OF THE DRAWINGS

FIG. 1 illustrates an example of a network environment, in accordance with some embodiments.

FIG. 2 illustrates a Fifth Generation (5G) network environment, in accordance with some embodiments.

FIG. 3 illustrates an example of a network coverage, in accordance with some embodiments.

FIG. 4 illustrates an example of a discontinuous coverage, in accordance with some embodiments.

FIG. 5 illustrates an example of a coverage map, in accordance with some embodiments.

FIG. 6 illustrates an example of a sequence diagram in the context of transferring coverage data by using a control plane, in accordance with some embodiments.

FIG. 7 illustrates another example of a sequence diagram in the context of transferring coverage data by using a control plane, in accordance with some embodiments.

FIG. 8 illustrates another example of a sequence diagram in the context of transferring coverage data by using a control plane, in accordance with some embodiments.

FIG. 9 illustrates an example of a sequence diagram in the context of transferring coverage data by using a user plane, in accordance with some embodiments.

FIG. 10 illustrates an example of a sequence diagram in the context of transferring coverage data by using a short message service, in accordance with some embodiments.

FIG. 11 illustrates an example of a sequence diagram in the context of transferring coverage data stored by an operation and maintenance server of a network, in accordance with some embodiments.

FIG. 12 illustrates an example of an operational flow/algorithmic structure implemented by a UE in the context of discontinuous network coverage, in accordance with some embodiments.

FIG. 13 illustrates an example of an operational flow/algorithmic structure implemented by a base station in the context of discontinuous network coverage, in accordance with some embodiments.

FIG. 14 illustrates an example of receive components, in accordance with some embodiments.

FIG. 15 illustrates an example of a UE, in accordance with some embodiments.

FIG. 16 illustrates an example of a base station, in accordance with some embodiments.

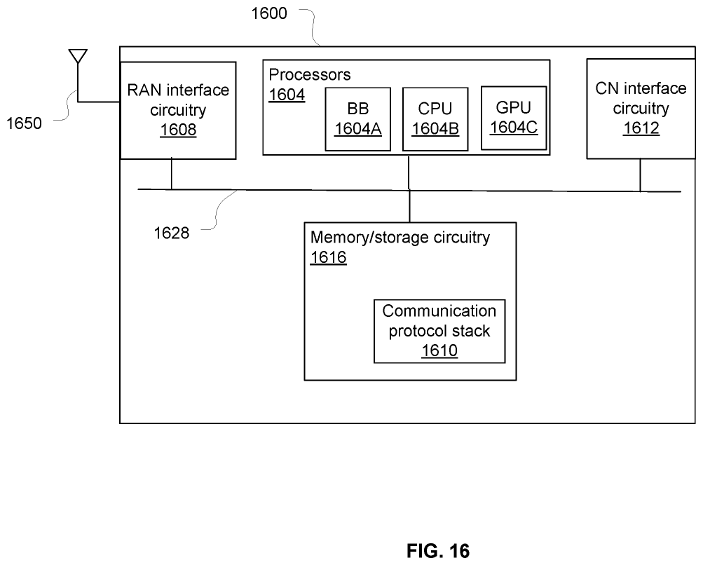

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art, having the benefit of the present disclosure, that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) communicates with a network when the UE is in a network coverage of the network. The network coverage can be provided via a base station of the network. The base station can be referred to as a network node and can be a component of a radio access network (RAN) portion of the network. In certain situations, the base station may be physically movable relative to the UE. For example, the base station can be implemented in a communications satellite that orbits around the Earth (in which case, the base station can be referred to as an NTN node). In other situations, the UE may be physically movable relative to the base station (e.g., when the UE is a mobile device traveling on a surface of Earth). Of course, there can be situations where both the UE and the base station are movable relative to each other.

When the network coverage provided by the base station is no longer available to the UE (e.g., because of an orbital location of a communications satellite and/or a geographical location of the UE), the UE may no longer be able to communicate with the network until the network coverage becomes available again to the UE (where this “re-coverage” can be provided by the same base station or a different base station). It is beneficial for at least the UE to determine when (e.g., in the future) the network coverage is (or will) available to it or not. For example, if during a next time interval, the network coverage is expected to be unavailable, the UE can forgo attempting to connect to the network, thereby reducing its power consumption. To perform such determination, the UE may receive coverage data from the network indicating the network coverage that can be provided thereto (e.g., the expected network coverage to be provided by a base station, such as by an NTN node). Based on the coverage data, the UE can determine the time interval during which the UE is in the network coverage and the time interval during which the UE is outside the network coverage. The former time interval may be referred to herein as an “access duration,” whereas the latter time interval may be referred to herein as a “gap duration” (to connote the fact that a network coverage gap exists).

Embodiments of the present disclosure enable various techniques for the coverage data to be transferred to the UE. In one example, the UE and the network (e.g., a control plane function of the network, such as an access and mobility management function (AMF)) can exchange capability information indicating a supported type of data transfer. This supported type can correspond to using a control plane, a user plane, a short message service (SMS), a system information block (SIB) broadcast, or a transfer originating from an operation and maintenance (O&M) server of the network. The coverage data is sent to the UE by using the supported type of data transfer (e.g., the control plane, the user plane, the SMS, the SIB broadcast, or the transfer from the O&M) server. This transfer can include particular information to enable the UE to receive and/or request the coverage data from the endpoint storing that data. Thereafter, the UE uses the coverage data to determine when the network coverage is available and to communicate with the relevant base station during the access duration.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE may have a primary function of communication with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

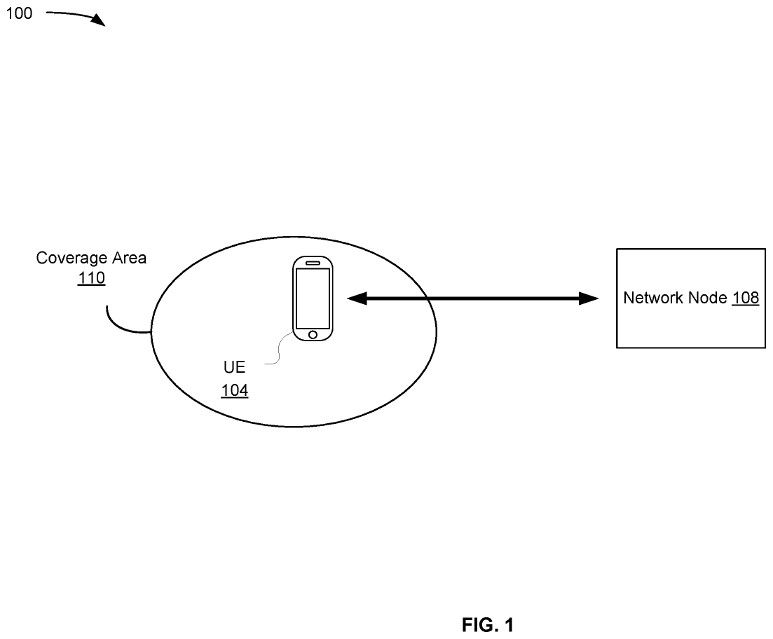

FIG. 1 illustrates a network environment 100, in accordance with some embodiments. The network environment 100 may include a UE 104 and a network node 108. The network node 108 may be a base station that provides a wireless access cell; for example, a Third-Generation Partnership Project (3GPP) New Radio (NR) cell, through which the UE 104 may communicate with the network node 108. This base station may be a component of a terrestrial network, a component of a non-terrestrial network, or components distributed between a terrestrial network and a non-terrestrial network. The UE 104 and the network node 108 may communicate over an interface compatible with 3GPP technical specifications, such as those that define Fifth Generation (5G) NR system standards.

The network node 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the network node 108 to allocate both uplink and downlink resources. The DCI may also be used to provide uplink power control commands, configure a slot format, or indicate that preemption has occurred.

The network node 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located (QCL) with one another. 3GPP has specified four types of QCL to indicate which particular channel characteristics are shared. In QCL Type A, antenna ports share Doppler shift, Doppler spread, average delay, and delay spread. In QCL Type B, antenna ports share Doppler shift and Doppler spread. In QCL Type C, antenna ports share Doppler shift and average delay. In QCL Type D, antenna ports share spatial receiver parameters.

The network node 108 may provide transmission configuration indicator (TCI) state information to the UE 104 to indicate QCL relationships between antenna ports used for reference signals (for example, synchronization signal/PBCH or CSI-RS) and downlink data or control signaling (for example, PDSCH or PDCCH). The network node 108 may use a combination of RRC signaling, MAC control element signaling, and DCI, to inform the UE 104 of these QCL relationships.

The UE 104 may transmit data and control information to the network node 108 using physical uplink channels. Different types of physical uplink channels are possible, including a physical uplink control channel (PUCCH) and a physical uplink shared channel (PUSCH). Whereas the PUCCH carries control information from the UE 104 to the network node 108, such as uplink control information (UCI), the PUSCH carries data traffic (e.g., end-user application data) and can carry UCI.

In an example, communications with the network node 108 and/or the base station can use channels in the frequency range 1 (FR1) band (between 40 Megahertz (MHz) and 7,125 MHz) and/or frequency range 2 (FR2) band (between 24,250 MHz and 52,600 MHz), although other frequency ranges are possible (e.g., a frequency range having a frequency larger than 52,600 MHz). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

As further illustrated in FIG. 1, the UE 104 can be located within a coverage area 110. In particular, the network node 108 may provide coverage area 110 with signaling (e.g., which may be carried by one or more beams). The coverage area 110 may represent a cell or a portion of the cell that the network node 108 provides. The coverage area 110 may contain multiple UEs, similar to the UE 104. These UEs may communicate with the network node 108 on both the uplink and the downlink based on channels available to them when the UEs are in the coverage area 110.

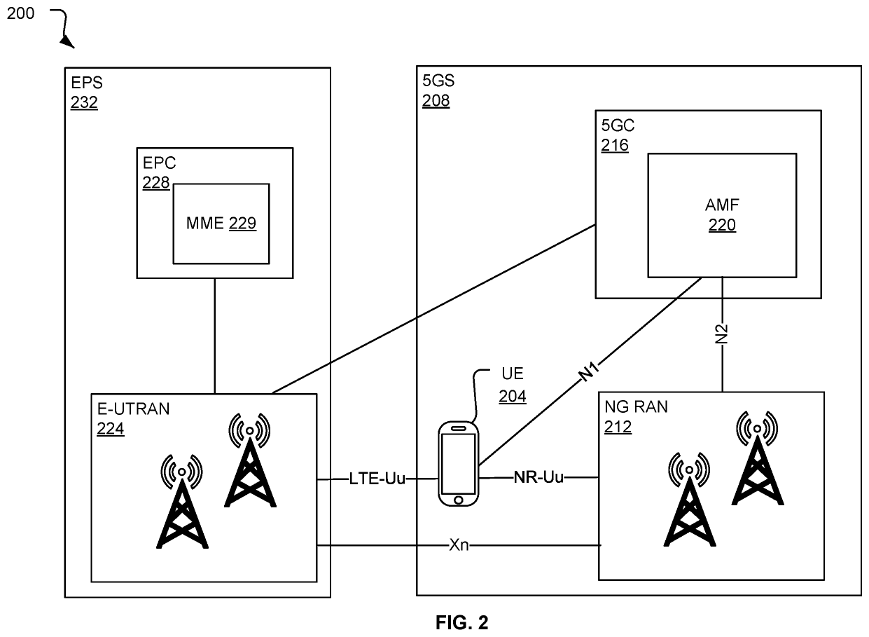

FIG. 2 illustrates a 5G network environment 200, in accordance with some embodiments. The network environment 200 may include a UE 204 that is part of a 5G system (5GS) 208. The UE 104 may be an example of the UE 104 of FIG. 1. The 5GS 208 may also include a 5G access network, for example, next generation (NG) radio access network (RAN) 212, and a 5G core network, for example, 5GC 216. The NG RAN 212 may include base stations, for example, gNBs, that provide new radio (NR) user plane and control plane protocol terminations toward the UE 204. The NG RAN 212 may be coupled with an an AMF 220 of the 5GC 216. The AMF 226 is an example of a control plane function of the 5GS 208.

The components of the network environment 200 may be coupled with one another over various interfaces (or reference points) that define signaling protocols between respective components. The interfaces may include a N1 interface between the UE 204 and the AMF 220 (e.g., between a NAS layer, or NAS for brevity, of the UE with the AMF 220); an N2 interface between the NG RAN 212 and the AMF 220; an NR-Uu interface between the UE 204 and the NG RAN 212; an LTE-Uu interface between the UE 204 and an evolved universal terrestrial access network (E-UTRAN) 224; and an Xn interface between the E-UTRAN 224 and the NG RAN 212. The E-UTRAN 224 may be part of an evolved packet system (EPS) 232 that includes an evolved packet core (EPC) 228. The EPC 228 may include a mobility management entity (MME) 229 that may be configured to provide a similar role as the AMF 220, except in the context of a E-UTRAN network. The MME 229 is an example of a control plane function of the EPS 232. An interface between the E-UTRAN 224 and the EPC 228 can be an Si interface. It will be understood that these interfaces define end-to-end signaling protocols between respective components. The actual signals may traverse through other components. For example, while signals between the AMF 220 and the UE 204 may be exchanged using N1 protocols, the signals may be communicated through one or more nodes of the NG RAN 212.

The AMF 220 may be a control plane function that provides registration management, connection management, reachability management, and mobility management services. Registration management may allow the UE 204 to register and deregister with the 5GS 208. Upon registration, the UE context may be created within the 5GC 216. The UE context may be a set of parameters that identify and characterize the UE 204. The UE context may include UE identity information, UE capability information, access and mobility information, or protocol data unit (PDU) session information.

The AMF 220, and 5GS 208, in general, may perform a number of registration area management functions to allocate/reallocate a registration area to the UE 204. A registration area may include a set of tracking areas, with each tracking area including one or more cells that cover a geographical area. A tracking area is identified by a tracking area identity, which may be broadcast in the cells of a tracking area.

Connection management may be used to establish and release control plane signaling connection between the UE 204 (e.g., the NAS) and the AMF 220. Establishing a control plane signaling connection moves the UE 204 from connection management (CM)-IDLE to CM-CONNECTED.

Mobility management may be used to maintain knowledge of a location of the UE 204 within a network. Mobility management may be performed by 5GS mobility management (5GMM) sublayers of the NAS within the UE 204 and the AMF 220 to support identification, security, and mobility of the UE 204 and to provide connection management services to other sublayers.

The 5GMM sublayers may be associated with different states that are independently managed per access type (for example, 3GPP access or non-3GPP access). The 5GMM sublayers may be in a 5GMM-DEREGISTERED state if no 5GMM context has been established and the UE location is not known to the network. To establish the 5GMM context, the sublayers may engage in an initial registration, to enter the 5GMM-REGISTERED-INITIATED state and, once the initial registration is accepted, the sublayers may enter the 5GMM-REGISTERED state with a 5GMM context established. From the 5GMM-REGISTERED state, the sublayers may enter a 5GMM DEREGISTERED-INITIATED state once a deregistration is requested. Once the deregistration is accepted, the sublayers may enter the 5GMM-DEREGISTERED state. From the 5GMM-REGISTERED state, the sublayers may also enter a 5GMM-SERVICE-REQUEST-INITIATED state by initiating a service request and may re-enter the 5GMM-REGISTERED state once the service request is accepted, rejected, or fails. A service request, as used herein, may refer to both control plane and user plane service requests.

The 5GMM sublayers may have 5GMM-CONNECTED mode and a 5GMM-IDLE mode that affect how the various procedures are performed.

A 5GMM-CONNECTED mode with RRC inactive indication (or RRC suspended state) is a NAS state introduced by 3GPP to improve resume and suspend operations of an RRC connection by reducing a time taken to reactivate the suspended bearer(s) as compared to long term evolution (LTE) methods to release an RRC connection and activate the RRC connection using a service request procedure. Faster resumption or suspension of active data radio bearers (DRBs) may improve user experience and reduce usage of radio resources.

The UE 204 can operate in a 5GMM-CONNECTED mode with an inactive indication (which can be thought of as a connectivity mode of the NAS layer with the AMF 220 over the signaling control plane) and in an RRC_INACTIVE state (which can be thought of as a connectivity state of the access stratum (AS) layer with the network over a data plane, whereby the UE 204 is not receiving and/or transmitting data). The UE 204 can also operate in the 5GMM-CONNECTED mode for the NAS layer and an RRC_CONNECTED state for the AS layer (whereby the UE 204 is receiving and/or transmitting data).

The UE 204 can implement as baseband processor that supports a non-access stratum (NAS) and an access stratum (AS) (also referred to herein as a NAS layer and an AS layer, respectively). The NAS may include a 5G NAS and a legacy NAS. The legacy NAS may include a communication connection with a legacy AS. The 5G NAS may include communication connections with both a 5G AS, a non-3GPP AS, and Wi-Fi AS. The 5G NAS may include functional entities associated with both access stratums. Thus, the 5G NAS may include multiple 5G MM entities and 5G session management (SM) entities. The legacy NAS may include functional entities such as a short message service (SMS) entity, an EPS session management (ESM) entity, a session management (SM) entity, an EPS mobility management (EMM) entity, and a mobility management (MM)/GPRS mobility management (GMM) entity. In addition, the legacy AS may include functional entities such as an LTE AS, a UMTS AS, and/or a GSM/GPRS AS.

The baseband processor architecture allows for a common 5G-NAS for both 5G cellular and non-cellular (e.g., non-3GPP access). The 5G MM may maintain individual connection management and registration management state machines for each connection. Additionally, the UE 204 may register to a single public land mobile network (PLMN) using 5G cellular access as well as non-cellular access. Further, it may be possible for the UE to be in a connected state in one access and an idle state in another access and vice versa. There may be common 5G-MM procedures (e.g., registration, de-registration, identification, authentication, as so forth) for both accesses.

In various embodiments, one or more of the above-described functional entities of the 5G NAS and/or 5G AS may be configured to perform methods for power savings in discontinuous coverage as further described herein.

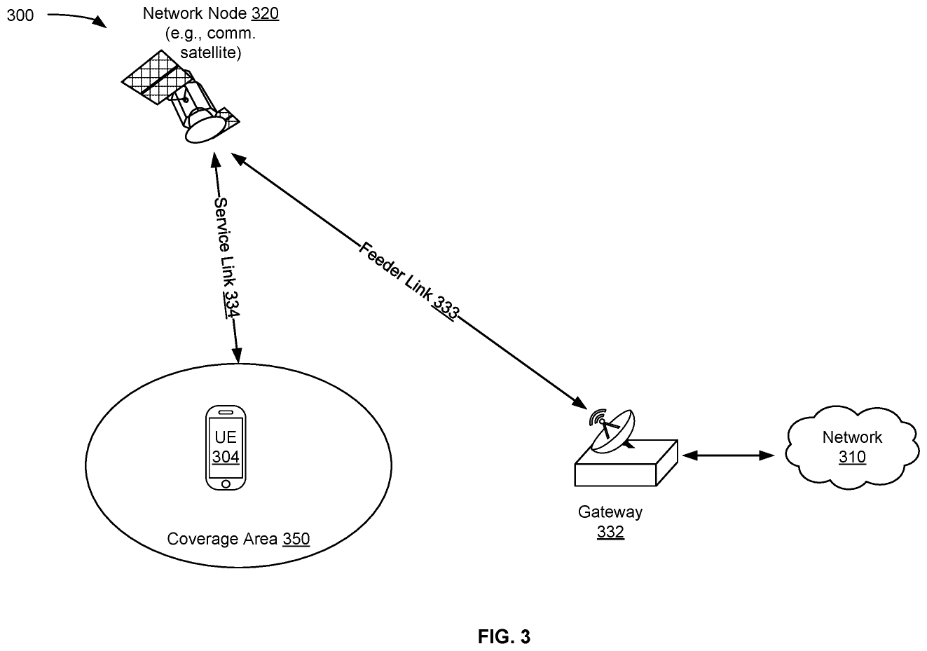

FIG. 3 illustrates an example of a network coverage 300, in accordance with some embodiments. A network 310 can be accessible to UEs via a network node 320 that supports multiple coverage areas. Each coverage area represents a geographical area within which the network coverage 300 is available. The support of the coverage areas may not be simultaneous. In particular, the network coverage 300 can be discontinuous across the coverage areas. For instance, the network coverage 300 may be available in a first coverage area for some time interval, while being unavailable in a second coverage area during that same time interval. During a different time interval, the network coverage 300 may no longer be available in the first coverage area, while being available in the second coverage area.

In an example, the network 310 can implement a particular set of radio access technologies (RATs) such as, but not limited to, 5G and/or different generation of a 3GPP network (e.g., one supported by the EPS 232 of FIG. 2). The network 310 can also be a terrestrial network, in which case the network node 320 can be a terrestrial access node, such as gNB or an eNB (or, more generally a terrestrial base station). In another example, the network 310 can be, at least in part, a non-terrestrial network where the network node 320 may be implemented on a communications satellite. In this case, the network node 320 may be referred to as a non-terrestrial base station or a non-terrestrial network node and may be coupled with the ground network via a gateway 332.

Generally, the network node 320 can cover a large geographical area, where this area can be divided in a large number of coverage areas (potentially in the hundreds, if not thousands). A UE 304 can be located in a coverage area (show as the coverage area 350 in FIG. 3) and can connect with the network node 320 via a feeder link 324. The feeder link 324 can use mmWave or sub-mmWave frequencies (e.g., in the S band or Ka band). In this way, the UE 304 can have access to the network 310 via the network node 320.

Network coverage can be available in a coverage area based on a set of beams directed from the network node 320 to that area. This coverage can be temporary and, thus, discontinuous. For instance, the set of beams can be directed to the coverage area 350 during a first time interval and directed to a different coverage area during a second time interval. Additionally, or alternatively, the network node 320 can be repositioned such that the direction of the set of beams changes from the coverage area 350 to the different coverage area.

As such, the network coverage 300 changes geographically over time. Relative to one particular coverage area (e.g., the coverage area 350), the network coverage 300 provided by the network 310 is a discontinuous network coverage in one or more coverage areas. For example, during certain time intervals, the network coverage 300 is available in the coverage area 350 (e.g., available to the UE 304 located in the coverage area 350). During other time intervals, the network coverage 300 is unavailable in the coverage area 350 (e.g., unavailable to the UE 304 located in the coverage area 350).

In the interest of clarity of explanation, various embodiments are described hereinafter in connection with a communications satellite as an example of the network node 320. However, the embodiments are not limited as such and similarly apply to any other base station (terrestrial or non-terrestrial) that belongs to a network providing a discontinuous network coverage and/or to any other UE to which the discontinuous network coverage may be provided. The discontinuity can be over time (e.g., even when the UE does not change location, the network coverage can be available to it during an access duration and then become unavailable during a gap duration). Additionally, or alternatively, the discontinuity can be geographic. For example, network coverage is available in a first area from a first base station, available in a second area from a second base station (or even the same first base station), and unavailable between the first area and the second area. In this example, the network coverage (or lack thereof) can depend on the location of the UE as it moves within each area and between the two areas. Of course, the discontinuity can be simultaneously time-based and geographic. Furthermore, causes of the discontinuous network coverage are described as being due to the repositioning of the communications satellite. However, other causes can exist including, for instance, changes to the beam direction and/or changes to a UE's position (e.g., where the UE may be re-located from a coverage area to a geographical area where the network coverage is not available). The embodiments similarly apply in situations where such discontinuous network coverage causes occur

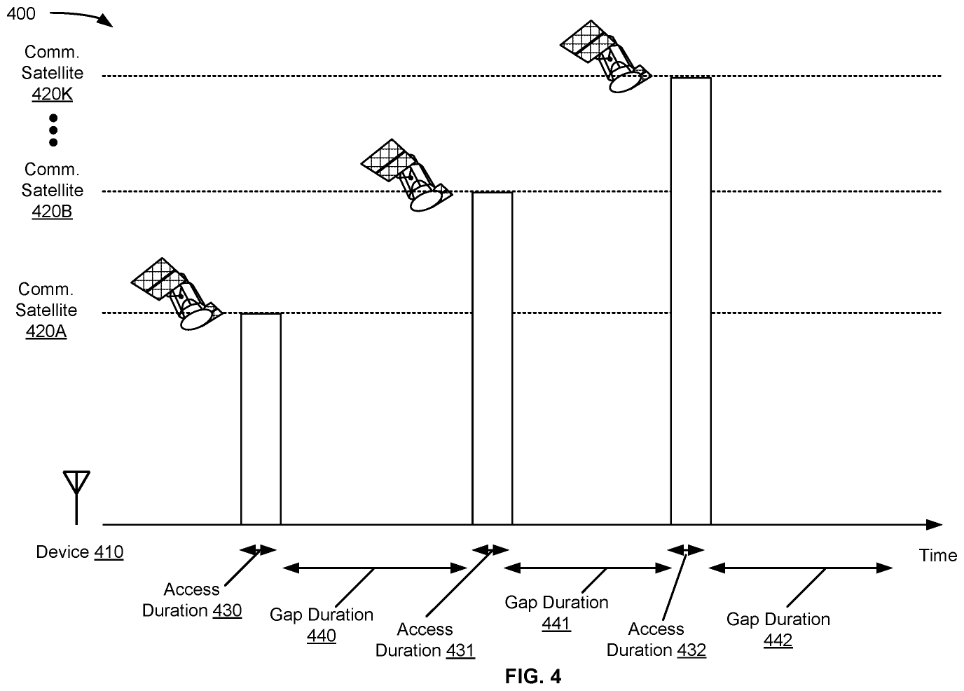

FIG. 4 illustrates an example of a discontinuous coverage 400, in accordance with some embodiments. Here, a UE 410 can be located at a location on Earth. The location may be stationary. A first communications satellite 420A may be orbiting over Earth and can be part of a network (e.g., by implementing a base station of the network or components of the base station, such as a modem thereof). The network can be a public land mobile network (PLMN). The radio frequency transmission of the communications satellite 420A reaches Earth and covers a geographic area, thereby providing network coverage to the geographic area (in this case, the network coverage can be referred to as satellite coverage). As the first communications satellite 420A orbits, the RF-covered geographic area changes, thereby changing the network coverage at least geographically. When the UE 410 is in the network coverage (e.g., its location is contained within the RF-covered geographic area), the UE 410 has access to the network. This time duration is illustrated as an access duration 430 in FIG. 4. When the UE 410 is outside the network coverage (e.g., its location is outside the RF-covered geographic area), the UE 410 no longer has access to the network (e.g., at least via the communications satellite 420A). This time duration is illustrated as a gap duration 440 in FIG. 4.

Depending on the orbiting of the communications satellite 420A, its RF transmission (e.g., beam direction) and the location of the UE 410, the network coverage may become again available to the UE 410 for another access duration via the communications satellite 420A. In other words, when considering only the communications satellite 420A, the UE 410 can be repeatedly in and out of the discontinuous network coverage 400.

As further illustrated in FIG. 4, multiple communications satellites (shown as communications satellite 420A, 420B, . . . , 420K) may be orbiting Earth. Such communications satellites may belong to the same network (e.g., to a home PLMN (HPLMN) of the UE 410) or to different networks (e.g., to the HPLMN and/or one or more visited PLMNs (VPLMNs)). As such, the UE 410 can be repeatedly in and out of the discontinuous network coverage 400 provided by such communication satellites depending on their orbit positions, RF transmissions, and the location of the UE 410. In the illustration of FIG. 4, the communications satellite 420A provides network coverage to the UE 410 during the access duration 430, then no network coverage is provided to the UE 410 during the gap duration 440. After the gap duration 440, the communications satellite 420B provides network coverage to the UE 410 during a next access duration 431, after which no network coverage is available to the UE 410 for the length of a gap duration 441. Thereafter also, the communications satellite 420K provides network coverage to the UE 410 during a subsequent access duration 432, after which no network coverage is available to the UE 410 for the length of a gap duration 442. Depending on the orbiting (e.g., velocity) and RF transmissions (e.g., beam width) of the communications satellite 420A-K, the length of the access durations 430, 431, and 432 can be different and each can vary over time, and, similarly, the length of the gap durations 440, 441, and 442 can be different and each can vary over time.

In an example, a communications satellite can be a non-geostationary satellite, such a Low-Earth-Orbit (LEO) satellite or a Medium-Earth-Orbit (MEO) satellite. LEO and MEO satellites are non-geostationary satellites orbiting around Earth with a period that varies approximately between 1.5 hour and 10 hours. LEO satellites orbit around Earth between 300-1500 km, and MEO satellites orbit around Earth between 7000-25000 km. Typically, a constellation of several non-geostationary satellites associated with handover mechanisms of a non-terrestrial network (NTN) can be used for service continuity.

In contrast, geostationary satellites have a circular orbit at 35,786 km above Earth's equator and follow the direction of Earth's rotation. An object in such an orbit has an orbital period equal to Earth's rotational period and thus appears motionless, at a fixed position in the sky, to ground UEs.

In case coverage gaps are not handled, the UE 410 may waste power searching for cells to monitor scheduled paging occasions that coincide with coverage gaps, and on cell searches when the UE 410 has data to transmit. The UE 410 that wishes to transmit or has been scheduled to monitor paging at a certain time of day (within a coverage gap) can find itself unable to receive transmission from a cell and, therefore, can attempt to find a new cell and reattach. In the worst case, the UE 410 may be unreachable from the network's point of view because scheduling occasions occur in coverage gaps. Furthermore, the UE 410 may be disconnected from the network and attempt cell-selection and registration (NAS attach) all over. To mitigate discontinuous coverage, the UE 410 and the network may need to be aware of gaps in coverage (e.g., be aware of discontinuous network coverage).

One discontinuous coverage mitigation approach involves providing coverage data to the UE 410. The coverage data can indicate where and/or when network coverage is expected, and/or where and/or when network coverage is not expected. Based on the coverage data, the UE 410 can determine whether network coverage is available thereto or not. The behavior of the UE 410 can be adopted depending on the availability of the network coverage. For example, when the network coverage is available, the access stratum layer of the UE 410 can be activated, and one or more non-access stratum procedures can be performed to establish communication between the UE and the network via a base station (e.g., a communications satellite). The UE 410 can then transfer data to the network and vice versa. When the network coverage is unavailable, the access stratum layer can be deactivated, and the non-access stratum layer of the UE 410 can be notified about this deactivation. The UE 410 can then forgo performing different procedures including non-access stratum procedures, thereby reducing its power consumption.

In the case of satellite coverage, a satellite orbit can be described by initial conditions and a set of orbital parameters. Satellite almanac contains the coarse orbit and is valid for scheduling purposes. The short-term ephemeris can be used for uplink synchronization and is provided in the form of two subsequent position broadcasts or the broadcast of position and velocity of the satellite. The Almanac and Ephemeris information can be broadcasted in SIBs for scheduling and synchronization purposes. A sib broadcast can be a communications satellite (e.g., configured as a base station). A UE at the edge of satellite coverage can receive and decode ephemeris information within their access window (e.g., the access duration 430 of FIG. 4). Almanac information can be available to the UE at least once per access window. This information can also be provided over NAS signaling during tracking area update procedure and/or an attach in EPS or a registration procedure in 5GS. The UE can use almanac-based predictions and ephemeris information to determine when satellite coverage will be available and thus optimize its cell search, PLMN selection and connectivity with network for power consumption. The network can provide next cell/satellite selection information or coverage gap information periodically to the UE during a TAU procedure or a mobility registration update (MRU) procedure, as applicable, to improve cell re-selection/PLMN selection procedure and reduce power consumption.

In addition or alternative to using SIB broadcasts for almanac and ephemeris information, various embodiments of the present disclosure also enable other techniques for the network to provide coverage data to the UE. These techniques include using a control plane, a user plane, SMS, or transfer of data from an O&M server of the network.

Different types of information can be included in the coverage data. For example, the coverage data can include the almanac information and/or ephemeris information, in case of satellite coverage. In this and/or other cases, the coverage data can additionally or alternatively include Earth location data indicating an area and whether coverage is available in the area or node and/or timing data indicating timing for when coverage in an area is available or unavailable.

In an example, the coverage data represents a coverage map and can be referred to herein coverage map data. The coverage data would indicate for one or more locations and/or one or more times in future whether a UE can expect to receive or not receive coverage from at least one of the satellite RATs (or, more generally, network nodes of a RAN including, for example, NTN nodes) at each of the locations and/or for each of the future times. The one or more locations may correspond to fixed locations (e.g., corresponding to grid points in a rectangular or hexagonal grid point array) or may correspond to locations along a known or predicted UE trajectory.

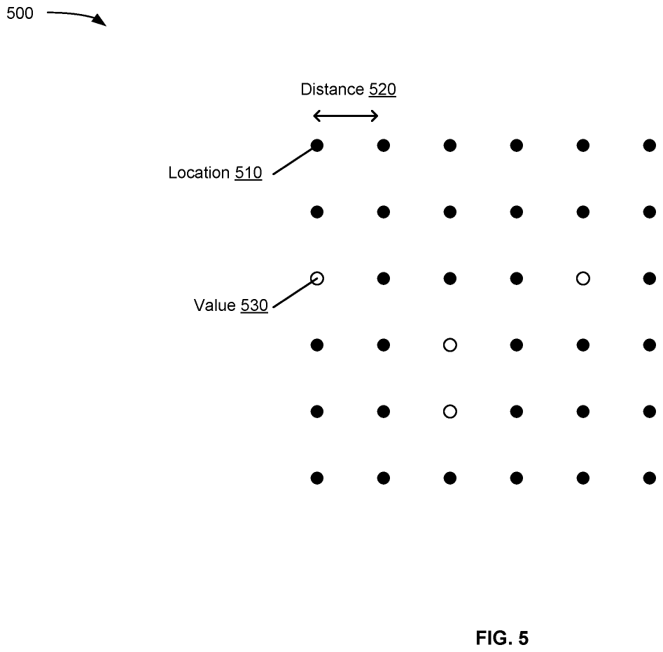

FIG. 5 illustrates an example of a coverage map 500, in accordance with some embodiments. Here, the coverage map 500 is described as indication location-based coverage data. As explained herein above, other types of information can be included in the coverage data, such as timing information, almanac information, and/or ephemeris information.

Generally, the coverage map 500 shows the expected coverage by one or more satellite RATs at one or more locations and for a particular time in the future. A set of coverage maps can then be provided for each of a sequence of times occurring at fixed periodic intervals, such as at intervals of one minute. The locations 510 supported by a coverage map can correspond to grid points in a rectangular (or possibly hexagonal) array. Each grid point (shown in FIG. 5 with a dot) represents one location 510. These locations 510 (e.g., grid points) can be spaced apart by a fixed distance 520 (e.g., 100 to 400 kms). The absolute location 510 of each grid point can then be known by specifying an absolute (global) location 510 for just one grid point in the array (e.g., a center grid point or a grid point at one corner). The expected satellite coverage at the location of each grid point can then be indicated by a value 530 (e.g., a binary value) indicating whether that coverage is expected to be either available or not available (e.g., a “zero” value indicates that the satellite coverage is expected to be unavailable shown in FIG. 5 with a blank dot, whereas a “one” value indicates that the satellite coverage is expected to be available shown in FIG. 5 with a solid dot). The coverage data representing the coverage map 510 (or a set of such coverage maps) can be provided to a UE from a control plane function of the network or from an endpoint outside of the network (where the information about this endpoint can be provided by a control plane function of the network to the UE).

Different types of data transfer can be supported for providing coverage data to a UE. These types include a control plane data transfer, a user plane data transfer, an SMS query, a SIB broadcast, and a data transfer associated with an O&M server. The appropriate type to use can depend on various parameters, such as the coverage data content (e.g., location data, timing data, almanac data, ephemeris data, etc.), the payload size, and/or frequency of updates. Based on the type and assuming that such type is supported by the UE and the network, a target layer in the UE and the network can be used. Security protocols can be used to ensure that the coverage data transfer is secure. In addition, a subscription of the UE with the network may be checked to determine, for example, whether the coverage data transfer is enabled (e.g., allowed via the subscription) to the UE and/or for charging an account for the coverage data transfer.

Generally, the used type of data transfer may be negotiated or coordinated between the UE and the network. For example, capability information can be exchanged about the data transfer type(s) supported by the UE and/or the network. Based on the capability information exchange, a selection can be made (e.g., by the network and/or the UE) to use a a supported type.

In an example, the UE sends UE capability information (e.g., via RRC signaling or NAS signaling) to the network indicating the UE-supported type(s) of data transfer. If multiple types are indicated, the UE can also indicate its preferred data transfer type and/or a prioritized list of the data transfer types. The network (e.g., a control plane function, such as AMF or MME) can select one of the UE-supported type(s) of data transfer and indicate this selection to the UE. The indication can be explicit (e.g., via an RRC message or NAS message) or implicit (e.g., whereby the network starts using the selected data transfer type to transfer the coverage data to the UE). In the case where the UE indicates a single UE-supported type of data transfer, the network may, but need not, send an acknowledgement and may start using this data transfer type.

The UE can indicate its UE capability for the data transfer type(s) in one or more mobility management capability information elements (IEs), such as 5GMM capability IEs. Such an IE can have a specific type corresponding to coverage map data transfer capability.

In another example, the network sends network capability information (e.g., via RRC signaling) to the UE indicating the network-supported type(s) of data transfer. If multiple types are indicated, the network can also indicate its preferred data transfer type and/or a prioritized list of the data transfer types. The UE can select one of the network-supported type(s) of data transfer and indicate this selection to the network. The indication can be explicit (e.g., via an RRC message) or implicit (e.g., whereby the UE starts using the selected data transfer type to receive the coverage data from the network). In the case where the network indicates a single network-supported type of data transfer, the UE may, but need not, send an acknowledgement and may start using this data transfer type.

The network can indicate its network capability for the data transfer type(s) in one or more network feature support IEs, such as 5GS network support IEs. Such an IE can have a specific type corresponding to coverage map data transfer capability.

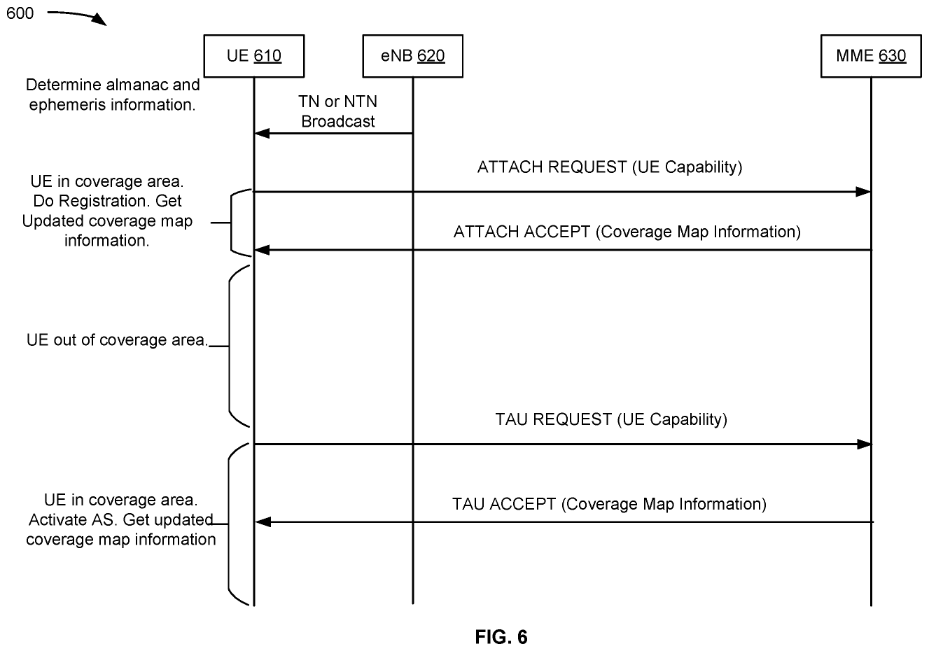

FIG. 6 illustrates an example of a sequence diagram 600 in the context of transferring coverage data by using a control plane, in accordance with some embodiments. The sequence diagram 600 is illustrated in connection with an EPS, whereby an MME of the EPS is used. However, the embodiments of the present disclosure are not limited as such, whereby other control plane functions of the EPS can be additionally or alternatively used.

The sequence diagram 600 can apply to a network that provides discontinuous network coverage (e.g., NTN) and that uses E-UTRAN technology. The network includes an eNB 620 (e.g., having components thereof that are implemented on a communications satellite) and an MME 630 (e.g., implemented as a ground component). The sequence diagram 600 includes a broadcast by the eNB 620, where this broadcast can indicate whether the network is a TN or an NTN. The broadcast can be received by a UE 610. For instance, the broadcast is a SIB1 broadcast. The broadcast can also include almanac and ephemeris information. As such, the UE 610 can determine whether the network is a TN or an NTN and can predict satellite coverage (or, more generally, network coverage) in the case of an NTN. In the case of an NTN, the UE may have previously camped on an NTN cell of this network. The UE can determine whether it is still camped on the same NTN cell based on, for instance, the cell ID, camped tracking area identity (TAI), and/or frequency characteristics. If it is the same NTN cell, the UE can skip reading the satellite coverage information (e.g., ephemeris and almanac information) if broadcasted by the NTN cell, as it will be same. In this way, the UE can conserve power by not reading the same information again.

When the UE 610 is in a coverage area (e.g., the network coverage is provided thereto by the eNB 620 or another eNB implemented on a communications satellite), the UE 610 can perform a number of procedures including an attach procedure. As part of the attach procedure, the UE 610 can send an ATTACH REQUEST message to the MME 630 via the applicable eNB. The ATTACH REQUEST message can include UE capability information indicating the UE capability for using a control plane for coverage data transfer. The MME 630 can respond with an ATTACH ACCEPT message. The attach accept message can include coverage map information. This information can include updated almanac and ephemeris information. This information can also or alternatively include location information and/or timing information from a coverage map. As such, the coverage map information includes one or more different types of information that is sent by the network (e.g., the MME 630) as part of coverage data to the UE 610. The UE 610 can determine whether network coverage is expected or not based on the coverage map information. This determination can include a prediction of where and/or when (and relevant access duration and/or gap durations) for the network coverage.

Next, the UE 610 is out of the coverage area. The UE 610 can operate in a power save mode. For instance, the AS layer is deactivated to conserve power. The NAS layer also can forgo various network operations. The network may also forgo paging.

Thereafter, when the UE 610 is in a coverage area again, the UE 610 can exit the power save mode. For instance, the AS layer is activated, and the NAS layer is notified. The UE 610 can perform a number of procedures including a TAU procedure. As part of the TAU procedure, the UE 610 sends a TAU REQUEST message to the MME 630 via the relevant eNB, where this request can indicate the UE capability for the coverage data transfer type(s). The MME 630 can send a TAU ACCEPT message via the relevant eNB. This message can include coverage map information (e.g., updated coverage map information) that are then used by the UE 610 to further determine the expected network coverage.

Although TAU-related messages are described in the sequence diagram 600 as being used for the coverage data transfer, other types of messages are possible. For example, a DOWNLINK GENERIC NAS TRANSPORT message can be used.

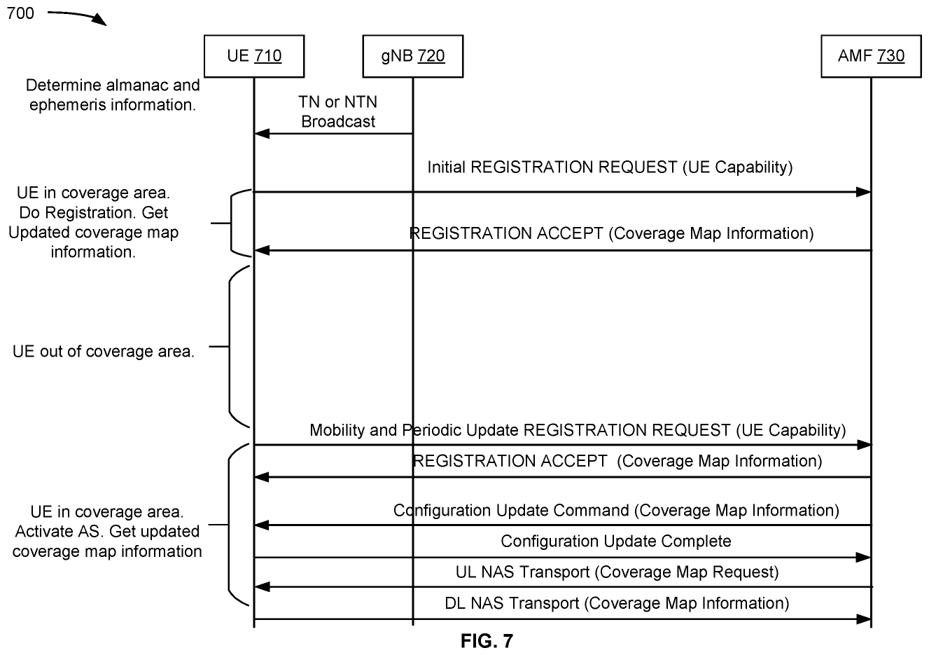

FIG. 7 illustrates another example of a sequence diagram 700 in the context of transferring coverage data by using a control plane, in accordance with some embodiments. The sequence diagram 600 is illustrated in connection with a 5GS, whereby an AMF of the 5GS is used. However, the embodiments of the present disclosure are not limited as such, whereby other control plane functions of the 5GS can be additionally or alternatively used.

The sequence diagram 700 can apply to a network that provides discontinuous network coverage (e.g., NTN) and that uses NG RAN technology. The network includes a gNB 720 (e.g., having components thereof that are implemented on a communications satellite) and an AMF 730 (e.g., implemented as a ground component). The sequence diagram 700 includes a broadcast by the gNB 720, where this broadcast can indicate whether the network is a TN or an NTN. The broadcast can be received by a UE 710. For instance, the broadcast is a SIB1 broadcast. The broadcast can also include almanac and ephemeris information. As such, the UE 710 can determine whether the network is a TN or an NTN and can predict satellite coverage (or, more generally, network coverage) in the case of an NTN.

When the UE 710 is in a coverage area (e.g., the network coverage is provided thereto by the gNB 720 or another gNB implemented on a communications satellite), the UE 710 can perform a number of procedures, including a registration procedure. As part of the registration procedure, the UE 710 can send a REGISTRATION REQUEST message to the AMF 730 via the applicable gNB. The REGISTRATION REQUEST message can include UE capability information indicating the UE capability for using a control plane for coverage data transfer. The AMF 730 can respond with a REGISTRATION ACCEPT message. The REGISTRATION ACCEPT message can include coverage map information. This information can include updated almanac and ephemeris information. This information can also or alternatively include location information and/or timing information from a coverage map. As such, the coverage map information includes one or more different types of information that is sent by the network (e.g., the AMF 730) as part of coverage data to the UE 710. The UE 710 can determine whether network coverage is expected or not based on the coverage map information. This determination can include a prediction of where and/or when (and relevant access duration and/or gap durations) for the network coverage.

Next, the UE 710 is out of the coverage area. The UE 710 can operate in a power save mode. For instance, the AS layer is deactivated to conserve power. The NAS layer also can forgo various network operations. The network may also forgo paging.

Thereafter, when the UE 710 is in a coverage area gain, the UE 710 can exit the power save mode. For instance, the AS layer is activated, and the NAS layer is notified. The UE 710 performs a number of procedures including a mobility and periodic update registration procedure. As part of this procedure, the UE 710 sends a mobility and periodic update REGISTRATION REQUEST message to the AMF 730 via the relevant gNB, where this request can indicate the UE capability. The AMF 730 can send a REGISTRATION ACCEPT message via the relevant gNB. This message can include coverage map information that is then used by the UE 710 to further determine the expected network coverage.

In an example, in addition or alternative to using the registration procedure to provide coverage data to the UE 710, a configuration update procedure and/or a NAS transport messaging can be used. For example, the AMF 730 can send a configuration update command message to the UE 710, where this message can include the coverage map information. In response, the UE 710 can send a configuration update complete message to the AMF 730. In another example, the UE can send an uplink NAS transport message to the AMF 730, where this message requests the coverage data. In response, the AMF 730 can send a downlink NAS transport message that includes the coverage map information.

In any of the above messages (e.g., a REGISTRATION ACCEPT message, a configuration update message, or a downlink NAS transport message), a container having a container type can be used, and one or more IEs can be added therein to include the coverage map information. The container can be a transparent container (e.g., one that can be encapsulated and/or that the gNB 720 does not decode).

The container type can be specific to coverage data described herein. For example, an IE of the payload container type value with a length of one octet is used per 3GPP TS24.501, Table 9.11.3.40.1. The octet can be set to a value indicating “satellite coverage map data.” The purpose of the payload container type IE indicates type of payload included in the payload container IE, is coded in the Table 9.11.3.40.1, and is a type 1 information element. As such, an existing payload container (e.g., per 3GPP TS24.501) can be used, but its payload container type IE can be updated to indicate “satellite coverage map data.” Both IP and non-IP based data can be transferred using control plane mechanism.

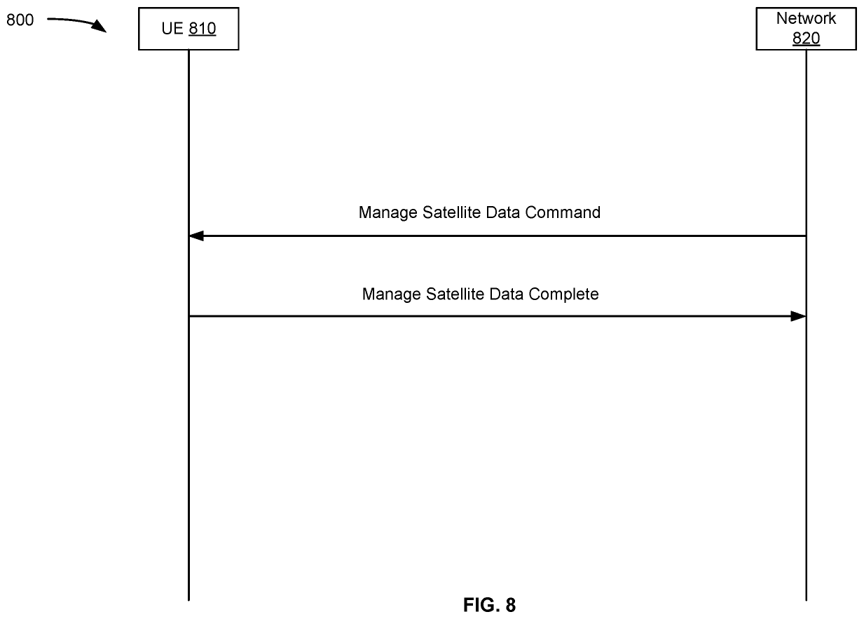

Additionally or alternatively, a new message exchange can be defined between the UE 710 and the AMF 730. For example, a new container and/or a new information element can be defined similar to the UE policy delivery service in Annex D of 3GPP TS24.501, V18.1.0 (2022-12), which is incorporated herein by reference in its entirety. An example, of new message is described in FIG. 8 in connection with a satellite data command as an example.

Referring back to FIGS. 6-7, these figures illustrate the use of a control plane data transfer. For power-efficient, relatively infrequent transfers of small amounts of coverage data, the control plane data transfer can be better that a use plane data transfer. The target layer for use of coverage data can be MME/AMF on the network side and the EMM/5GMM NAS layer on the UE side. When more than one message is sent, transport features such as packet numbering, in-sequence delivery, and acknowledgments need not directly provided by the NAS transfer. Such transfer features can be made available through a higher layer protocol, such a control plane protocol other than a NAS protocol. An example of such a protocol is the reliable data service (RDS) described in 4GPP TS 24.250, V17.0.0 (2022-05), which is incorporated herein by reference in its entirety.

RDS supports peer-to-peer data transfers and provides reliable data delivery between the UE and the network. In EPS, the data is transferred via a packet data network (PDN) connection between the UE and a service capability exposure function (SCEF) or a PDN gateway (P-GW). In 5GS, the data is transferred between the UE and a network exposure function (NEF) or a user plane function (UPF) via a protocol data unit (PDU) session between the UE and a session management function (SMF).—RDS supports multiple applications on the UE to simultaneously conduct data transfers with their peer entities on the network using a single PDN connection or a PDU session between the UE and the network. In 5GS, the UE establishes a PDU session with the SMF through UE requested PDU session establishment procedure. The UE uses the PDU session identity and a quality of service (QoS) flow identifier to select the flow to transfer RDS PDUs to the NEF or UPF. The PDU session identity identifies the destination (at the UE or at the NEF or UPF) and is not carried in the frame as it is already included in the NAS 5GSM message header. The UE sends RDS request in an uplink NAS transport message, and the network responds with a response in downlink NAS transport message. When using RDS, the UE can send request for data in an uplink NAS transport message and RDS can respond with multiple downlink NAS transport messages which can carry satellite coverage data. RDS can be used for both IP and non-IP based data delivery.

Generally, the size of the data that is transferred can be limited to 65K octets. The data transfer can be done using transparent containers or by using specific IEs. Existing NAS security mechanism applies to ensure the security of the data transfers. Further, existing UE subscription can be taken into account and UE can be charged accordingly.

FIG. 8 illustrates another example of a sequence diagram 800 in the context of transferring coverage data by using a control plane, in accordance with some embodiments.

Here, the coverage data transfer involves using a “manage satellite data command” message, which can be a new type of messages defined for transferring coverage map information. As illustrated, a network 820 (e.g., a control plane function thereof) can send a manage satellite data command message to a UE 810. This message can include the coverage map information, as described herein above and elsewhere in the present disclosure. In response, the UE 810 can send a manage satellite data complete message based on successfully receiving the coverage data payload. This message can represent a response manage satellite data command message and/or an acknowledgement that the coverage map information was received.

In an example, an application function (AF), a policy control function (PCF), or some other entity (or control plane function) of the network 820 may provide coverage data to the UE 810 in a similar manner as how a UE policy is delivered to UE as described in annex D.2 of 3GPP TS 24.501. For example, the manage satellite data command message can include indicating a procedure transaction identity (PTI), a manage satellite data command message, identity, a payload container type for a container type, and the container type. The payload container type can be set to have a value indicating “satellite coverage map data.” The manage satellite data complete message can include the PTO and manage satellite data complete message identity.

Although the sequence diagram 800 is illustrated as being separate from the sequence diagram 600 of FIG. 6 and the sequence diagram 700 of FIG. 7, the steps of the sequence diagram 800 can be used in conjunction with or as part of the steps of the sequence diagram 600 and/or the sequence diagram 700. For example, after an attach procedure is performed (as in the sequence diagram 600) or after a registration procedure is performed (as in the sequence diagram 700), the network 820 can send the manage satellite data command message to the UE 810 (assuming that the UE 810 is in a coverage area).

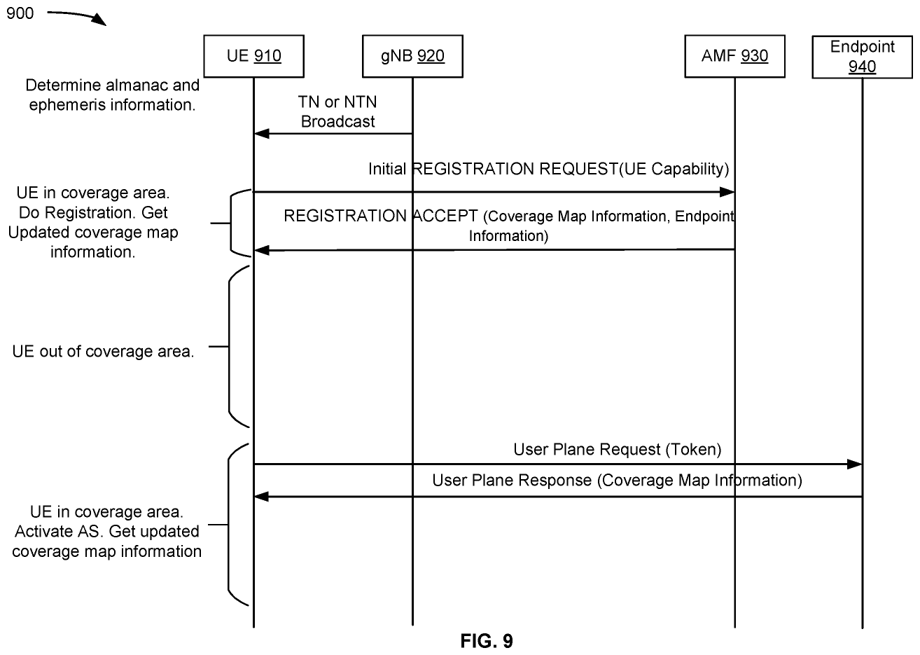

Referring back to FIGS. 6-8, these figures illustrate the use of a control plane to transfer coverage data by a control plane function. Other possible approaches for the coverage data transfers are possible and are further illustrated in FIGS. 9-11. In the interest of clarity of explanation, sequence diagrams of FIGS. 9-11 are illustrated in connection with a 5GS. However, similar sequence diagrams also apply to an EPS. For example, rather than an AMF, an MME can be involved as illustrated in FIG. 6. Further, rather than an initial registration request, an attach request can be used as illustrated in FIG. 6.

FIG. 9 illustrates an example of a sequence diagram 900 in the context of transferring coverage data by using a user plane, in accordance with some embodiments. The sequence diagram 900 can apply to a network that provides discontinuous network coverage (e.g., NTN) and that uses NG RAN technology. The network includes a gNB 920 (e.g., having components thereof that are implemented on a communications satellite) and an AMF 930 (e.g., implemented as a ground component). The sequence diagram 900 includes a broadcast by the gNB 920, where this broadcast can indicate whether the network is a TN or an NTN. The broadcast can be received by a UE 910. For instance, the broadcast is a SIB1 broadcast. The broadcast can also include almanac and ephemeris information. As such, the UE 910 can determine whether the network is a TN or an NTN and can predict satellite coverage (or, more generally, network coverage) in the case of an NTN.

When the UE 910 is in a coverage area (e.g., the network coverage is provided thereto by the gNB 920 or another gNB implemented on a communications satellite), the UE 910 can perform a number of procedures, including a registration procedure. As part of the registration procedure, the UE 910 can send a REGISTRATION REQUEST message to the AMF 930 via the applicable gNB. The REGISTRATION REQUEST message can include UE capability information indicating the UE capability for using a user plane for coverage data transfer. The AMF 930 can respond with a REGISTRATION ACCEPT message. The REGISTRATION ACCEPT message can include coverage map information and endpoint information. The coverage map information can include updated almanac and ephemeris information. This information can also or alternatively include location information and/or timing information from a coverage map. As such, the coverage map information includes one or more different types of information that is sent by the network (e.g., the AMF 930) as part of coverage data to the UE 910. The UE 910 can determine whether network coverage is expected or not based on the coverage map information. This determination can include a prediction of where and/or when (and relevant access duration and/or gap durations) for the network coverage. The endpoint information can include information about an endpoint 940 that stores the coverage map information and/or information about accessing the coverage map information from the endpoint 940. Generally, the endpoint 940 may belong to the network and a connection thereto can be established via a control plane function of the network (e.g., via an AF or a SMF). The endpoint information can include an address of the endpoint (e.g., a network address such as a uniform resource identifier (URI) or a uniform resource locator (URL)) and a token. The token can be used to validate that the UE 910 is authorized to access the coverage map information and can be referred to herein as an authorization token.

Next, the UE 910 is out of the coverage area. The UE 910 can operate in a power save mode. For instance, the AS layer is deactivated to conserve power. The NAS layer also can forgo various network operations. The network may also forgo paging.

Thereafter, when the UE 910 is in a coverage area gain, the UE 910 can exit the power save mode. For instance, the AS layer is activated, and the NAS layer is notified. Based on the activated AS layer, the UE 910 can send a user plane request to the endpoint 940. The user plane request can include the token, such that the endpoint 940 can determine that the UE 910 is authorized to receive the coverage map information. In an example, the user plane request can be a hypertext transfer protocol secure (HTTPS) GET REQUEST that uses the network address of the endpoint 940. In turn, the endpoint 940 can send a user plane response to the UE 910. This response can include coverage map information. In an example, the response can be an HTTPS 200 OK response. The UE 910 then uses the received coverage map information to further determine the expected network coverage.

Generally, the user plane data transfer can be used for the transfer of more frequent and/or larger amounts of coverage data than the control plane data transfer. In the user plane data transfer case, the data transfer typically originates from external servers that can be treated as an application function AF. Transport features such as packet numbering, in-sequence delivery, and acknowledgments can be directly provided based on a user plane protocol (e.g., an HTTPS protocol). The data transfer can be done using transparent containers or by using specific IEs. The size of data can be larger than 65K octets. User plane security mechanisms, such as ones provided by HTTPS, are established. Existing UE subscription can be taken into account and the UE 910 can be charged accordingly. The UE 910 can send an HTTPS Get request {URI=authorization data}, and the endpoint 940 can return HTTPS 200 OK message with the coverage data. UE can obtain the authorization data (e.g., the authorization token) and the endpoint's 940 network address using a registration procedure. The authorization token included in Get request can be used to validate the request. Alternatively, or additionally, some or all of the endpoint information can be server configuration information pre-configured in a universal subscriber identity module (USIM) of the UE 910. For example, the USIM can store the network address and/or the authorization token. In such a case, the network (e.g., the AMF 930) can send updated endpoint information (e.g., an updated network address) or needed endpoint information (e.g., an authorization token when such a token is not stored in the USIM) to the UE 910.

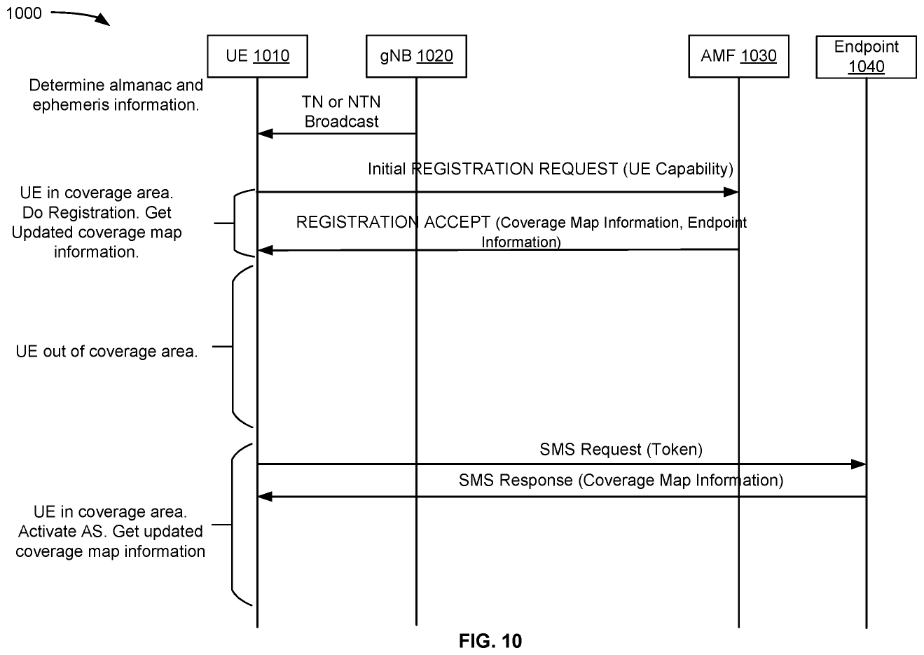

FIG. 10 illustrates an example of a sequence diagram 1000 in the context of transferring coverage data by using a short message service, in accordance with some embodiments. The sequence diagram 1000 can apply to a network that provides discontinuous network coverage (e.g., NTN) and that uses NG RAN technology. The network includes a gNB 1020 (e.g., having components thereof that are implemented on a communications satellite) and an AMF 1030 (e.g., implemented as a ground component). The sequence diagram 1000 includes a broadcast by the gNB 1020, where this broadcast can indicate whether the network is a TN or an NTN. The broadcast can be received by a UE 1010. For instance, the broadcast is a SIB1 broadcast. The broadcast can also include almanac and ephemeris information. As such, the UE 1010 can determine whether the network is a TN or an NTN and can predict satellite coverage (or, more generally, network coverage) in the case of an NTN.

When the UE 1010 is in a coverage area (e.g., the network coverage is provided thereto by the gNB 1020 or another gNB implemented on a communications satellite), the UE 1010 can perform a number of procedures, including a registration procedure. As part of the registration procedure, the UE 1010 can send a REGISTRATION REQUEST message to the AMF 1030 via the applicable gNB. The REGISTRATION REQUEST message can include UE capability information indicating the UE capability for using SMS for coverage data transfer. The AMF 1030 can respond with a REGISTRATION ACCEPT message. The REGISTRATION ACCEPT message can include coverage map information and endpoint information. The coverage map information can include updated almanac and ephemeris information. This information can also or alternatively include location information and/or timing information from a coverage map. As such, the coverage map information includes one or more different types of information that is sent by the network (e.g., the AMF 1030) as part of coverage data to the UE 1010. The UE 1010 can determine whether network coverage is expected or not based on the coverage map information. This determination can include a prediction of where and/or when (and relevant access duration and/or gap durations) for the network coverage. The endpoint information can include information about an endpoint 1040 that stores the coverage map information and/or information about accessing the coverage map information from the endpoint 1040. Generally, the endpoint 1040 may belong to the network and a connection thereto can be established via a control plane function of the network (e.g., via an SMS function (SMSF) that supports the transfer of SMS over NAS). The endpoint information can include an address of the endpoint (e.g., a network address such as a uniform resource identifier (URI) or a uniform resource locator (URL)) and a token. The token can be used to validate that the UE 1010 is authorized to access the coverage map information and can be referred to herein as an authorization token.

Next, the UE 1010 is out of the coverage area. The UE 1010 can operate in a power save mode. For instance, the AS layer is deactivated to conserve power. The NAS layer also can forgo various network operations. The network may also forgo paging.

Thereafter, when the UE 1010 is in a coverage area gain, the UE 1010 can exit the power save mode. For instance, the AS layer is activated, and the NAS layer is notified. The UE 1010 can send an SMS request to the endpoint 1040 (e.g., via the SMSF). The SMS request can be an SMS query and can include the token, such that the endpoint 1040 can determine that the UE 1010 is authorized to receive the coverage map information. In turn, the endpoint 1040 can send an SMS response to the UE 1010. This response can include coverage map information.

Generally, the SMS data transfer can be used for power-efficient, relatively infrequent transfers of small amounts of data. The target layer for use of coverage data can be AMF on the network side and the EMM/5GMM NAS layer on the UE side. The size of data can be limited to 160 octets, although the UE 1010 can use concatenated SMS to send larger amounts of data. Existing NAS security mechanism applies to ensure the security of the coverage data transfer. Existing UE subscription can be taken into account, and the UE 1010 can be charged accordingly. The UE 1010 can send an SMS query request, and the endpoint 1040 can return SMS message with the coverage map data. The UE 1010 can obtain the authorization data (e.g., the authorization token) using a registration procedure, that can be included in query. Alternatively, or additionally, some or all of the endpoint information can be server configuration information pre-configured in a USIM of the UE 1010. For example, the USIM can store the network address and/or the authorization token. In such a case, the network (e.g., the AMF 1030) can send updated endpoint information (e.g., an updated network address) or needed endpoint information (e.g., an authorization token when such a token is not stored in the USIM) to the UE 1010.

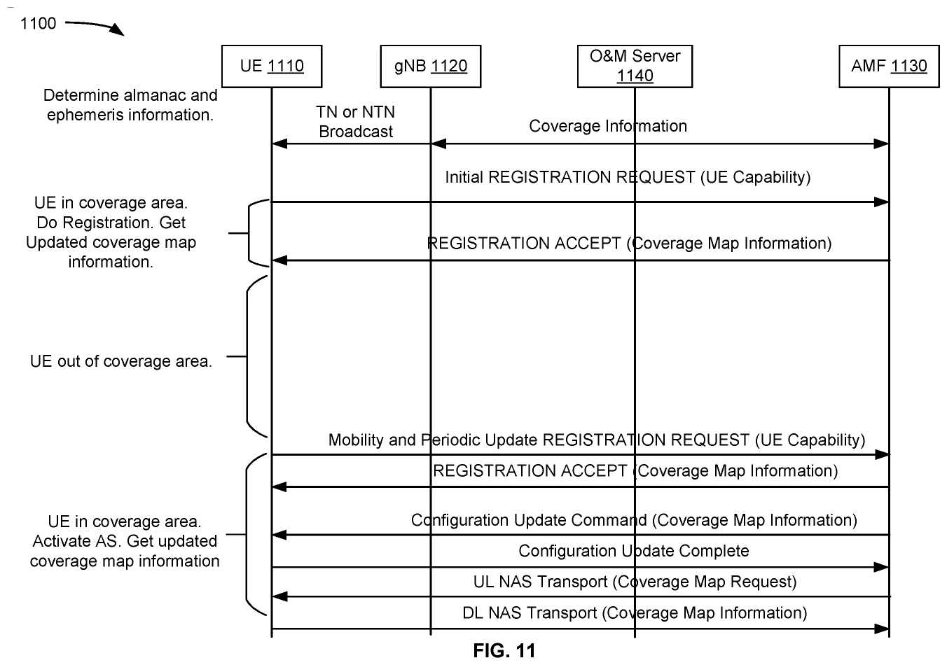

FIG. 11 illustrates an example of a sequence diagram 1100 in the context of transferring coverage data stored by an operation and maintenance (O&M) server 1140 of a network, in accordance with some embodiments. The sequence diagram 1100 can apply to a network that provides discontinuous network coverage (e.g., NTN) and that uses NG RAN technology. Generally, the O&M server 1140 can receive and store coverage map information from an endpoint external to the network. The stored coverage map information can then be provided to different entities of the network, such as to a gNB 1120 and/or an AMF 1020.

The gNB 1120 can send a broadcast indicating whether the network is a TN or an NTN. The broadcast can be received by a UE 1110. For instance, the broadcast is a SIB1 broadcast. The broadcast can also include almanac and ephemeris information (and/or other types of information received from the O&M server 1140). As such, the UE 1110 can determine whether the network is a TN or an NTN and can predict satellite coverage (or, more generally, network coverage) in the case of an NTN.

When the UE 1110 is in a coverage area (e.g., the network coverage is provided thereto by the gNB 1120 or another gNB implemented on a communications satellite), the UE 1110 can perform a number of procedures, including a registration procedure. As part of the registration procedure, the UE 1110 can send a REGISTRATION REQUEST message to the AMF 1130 via the applicable gNB. The REGISTRATION REQUEST message can include UE capability information indicating the UE capability for using a control plane, a user plane, and/or SMS for coverage data transfer. The AMF 1130 can respond with a REGISTRATION ACCEPT message. The REGISTRATION ACCEPT message can include coverage map information and, as applicable, endpoint information. The remaining steps of the sequence diagram 1100 are similar to those of sequence diagrams 600-1000 depending on whether a control plane data transfer, a user plane data transfer, and/or an SMS data transfer are used. The similarities are note repeated herein. Instead, the steps equally or equivalently apply to the sequence diagram 1100.

In the context of the O&M server 1140, the coverage map information is typically RAT and location related and not tied to UE subscription and is generally not UE specific. This information can be provisioned directly from external AF to MME/AMF and may not work well for all UEs except for specific use cases where a UE is aware of ephemeris and/or almanac information and can acquire up-to-date coverage map information. The AF can provision non UE specific information to the O&M server(s) 1140 in the network. Thereafter, based on UE specific requirements, coverage map information can be retrieved by the UE in both EPS and 5GS.

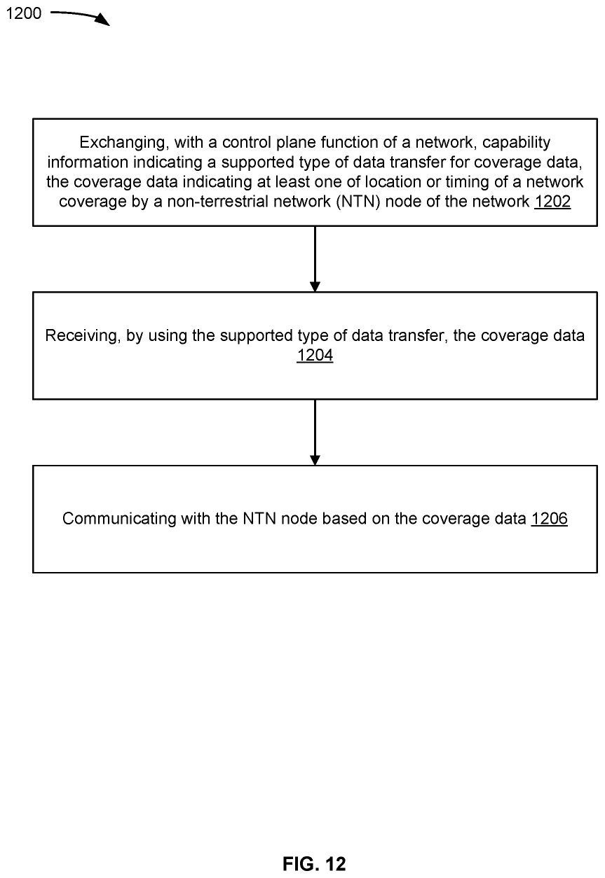

FIG. 12 illustrates an example of an operational flow/algorithmic structure 1200 implemented by a UE (or a component thereof) in the context of discontinuous network coverage, in accordance with some embodiments. The UE is an example of any of the UEs described in the present disclosure. The discontinuous network coverage may be available from an NTN.

The operational flow/algorithmic structure 1200 may include, at 1202, exchanging, with a control plane function of a network, capability information indicating a supported type of data transfer for coverage data, the coverage data indicating at least one of location or timing of a network coverage by a non-terrestrial network (NTN) node of the network. For example, UE capability information can be sent from the UE to the network (e.g., to control plane function thereof via a base station thereof) and/or network capability information can be sent from the network to the UE (e.g., from the control plane function via the base station). If multiple data transfer types are supported, a selection by the UE and/or the network can be made to use the supported type. In an illustrative use case, a component of the UE includes processing circuitry configured to cause an exchange of the capability information with the control plane function of the network.

The operational flow/algorithmic structure 1200 may include, at 1204, receiving, by using the supported type of data transfer, the coverage data. For example, the supported type can be any of a control plane transfer, a user plane transfer, an SMS transfer, or a transfer originating from an O&M server of the network. In the case of a control plane or O&M server-originating transfer, the coverage data can correspond to coverage map information received from an MME or AMF of the network (or another control plane function thereof) as described in FIGS. 6-8 and 11. In the case of a user plane or SMS transfer, the coverage data can correspond to coverage map information received from an endpoint external to the network as described in FIGS. 9-10. In an illustrative use case, the processing circuitry is further configured to process, by using the supported type of data transfer, the coverage data.

The operational flow/algorithmic structure 1200 may include, at 1206, communicating with the NTN node based on the coverage data. For example, the UE (e.g., the processing circuitry) determines whether the UE is in a coverage area of the NTN node (e.g., a non-terrestrial base station of the network) based on the received coverage data. When in the coverage area, the UE activates its AS layer. When outside the coverage area, the UE enters a power save mode. In an illustrative use case, the processing circuitry is further configured to cause communication with the NTN node based on the coverage data.

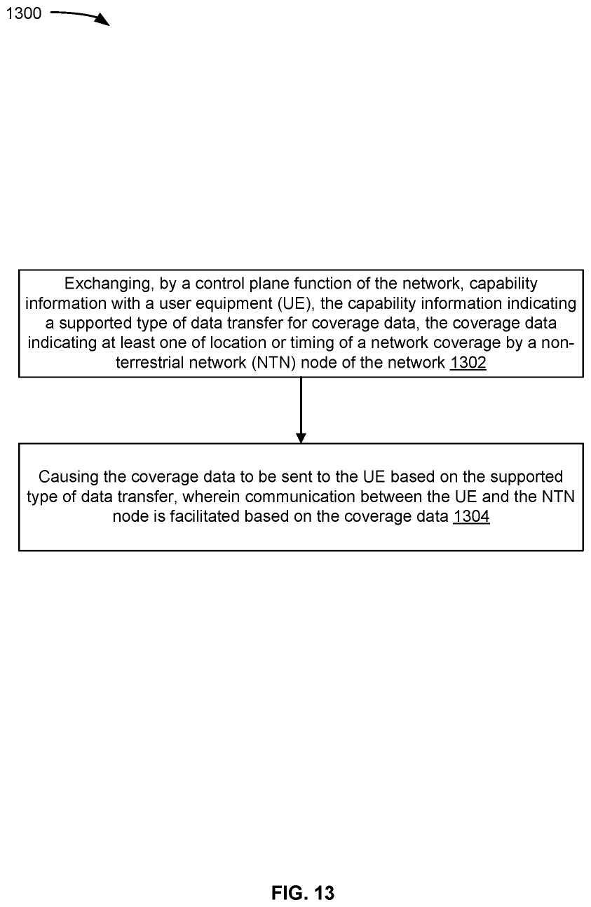

FIG. 13 illustrates an example of an operational flow/algorithmic structure 1300 implemented by a base station in the context of discontinuous network coverage, in accordance with some embodiments. The base station is an example of any of the base stations described in the present disclosure. The discontinuous network coverage may be available from an NTN.

The operational flow/algorithmic structure 1300 may include, at 1302, exchanging, by a control plane function of the network, capability information with a user equipment (UE), the capability information indicating a supported type of data transfer for coverage data, the coverage data indicating at least one of location or timing of a network coverage by a non-terrestrial network (NTN) node of the network. For example, UE capability information can be sent from the UE to the network (e.g., to control plane function thereof via a base station thereof) and/or network capability information can be sent from the network to the UE (e.g., from the control plane function via the base station). If multiple data transfer types are supported, a selection by the UE and/or the network can be made to use the supported type.

The operational flow/algorithmic structure 1300 may include, at 1304, causing the coverage data to be sent to the UE based on the supported type of data transfer, wherein communication between the UE and the NTN node is facilitated based on the coverage data. For example, the supported type can be any of a control plane transfer, a user plane transfer, an SMS transfer, or a transfer originating from an O&M server of the network. In the case of a control plane or O&M server-originating transfer, the coverage data can correspond to coverage map information received from an MME or AMF of the network (or another control plane function thereof) as described in FIGS. 6-8 and 11. In the case of a user plane or SMS transfer, the coverage data can correspond to coverage map information received from an endpoint external to the network as described in FIGS. 9-10. Based on the received coverage data, the UE determines whether the UE is in a coverage area of the NTN node (e.g., a non-terrestrial base station of the network). When in the coverage area, the UE activates its AS layer. When outside the coverage area, the UE enters a power save mode.

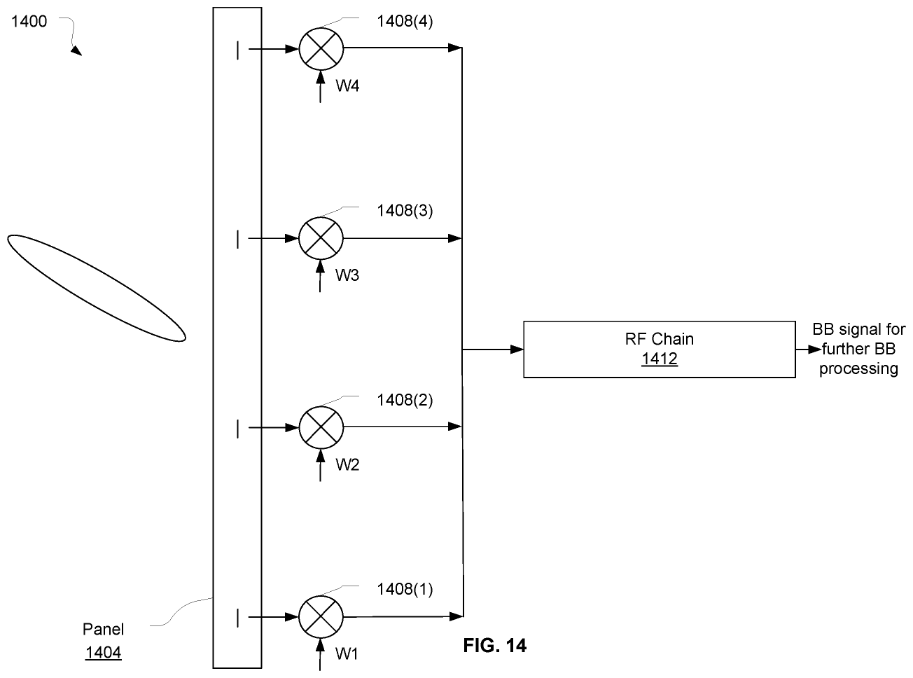

FIG. 14 illustrates receive components 1400 of the UE 104, in accordance with some embodiments. A device, such as one described in any of the above figures, can include similar receive components. The receive components 1400 may include an antenna panel 1404 that includes a number of antenna elements. The panel 1404 is shown with four antenna elements, but other embodiments may include other numbers.

The antenna panel 1404 may be coupled to analog beamforming (BF) components that include a number of phase shifters 1408(1)-1408(4). The phase shifters 1408(1)-1408(4) may be coupled with a radio-frequency (RF) chain 1412. The RF chain 1412 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1408(1)-1408(4) to provide a receive beam at the antenna panel 1404. These BF weights may be determined based on the channel-based beamforming.

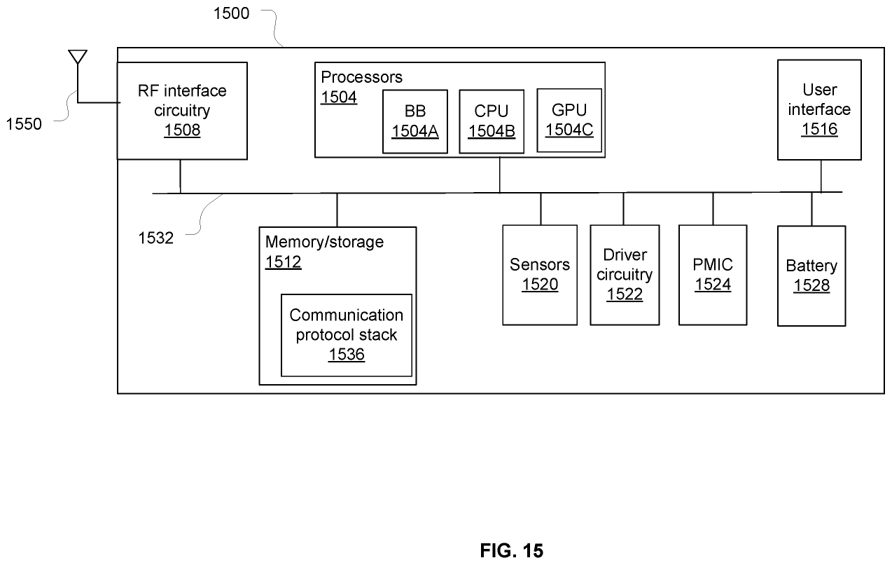

FIG. 15 illustrates a UE 1500, in accordance with some embodiments. The UE 1500 may be similar to and substantially interchangeable with UE 104 of FIG. 1. A device, such as one described in any of the above figures, can include similar components, including for instance, processors, memory, and RF interface circuitry.

Similar to that described above with respect to UE 104, the UE 1500 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1500 may include processors 1504, RF interface circuitry 1508, memory/storage 1512, user interface 1516, sensors 1520, driver circuitry 1522, power management integrated circuit (PMIC) 1524, and battery 1528. The components of the UE 1500 may be implemented as integrated circuits (ICs), portions thereof, discrete electronic devices, or other modules, logic, hardware, software, firmware, or a combination thereof. The block diagram of FIG. 15 is intended to show a high-level view of some of the components of the UE 1500. However, some of the components shown may be omitted, additional components may be present, and different arrangements of the components shown may occur in other implementations.

The components of the UE 1500 may be coupled with various other components over one or more interconnects 1532, which may represent any type of interface, input/output, bus (local, system, or expansion), transmission line, trace, optical connection, etc., that allows various circuit components (on common or different chips or chipsets) to interact with one another.

The processors 1504 may include processor circuitry, such as baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage 1512 to cause the UE 1500 to perform operations as described herein.

In some embodiments, the baseband processor circuitry 1504A may access a communication protocol stack 1536 in the memory/storage 1512 to communicate over a 3GPP compatible network. In general, the baseband processor circuitry 1504A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1508.

The baseband processor circuitry 1504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1504A may also access group information from memory/storage 1512 to determine search space groups in which a number of repetitions of a PDCCH may be transmitted.

The memory/storage 1512 may include any type of volatile or non-volatile memory that may be distributed throughout the UE 1500. In some embodiments, some of the memory/storage 1512 may be located on the processors 1504 themselves (for example, L1 and L2 cache), while other memory/storage 1512 is external to the processors 1504 but accessible thereto via a memory interface. The memory/storage 1512 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1508 may include transceiver circuitry and a radio frequency front module (RFEM) that allows the UE 1500 to communicate with other devices over a radio access network. The RF interface circuitry 1508 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1550 and proceed to filter and amplify (with a low-noise amplifier) the signal. The signal may be provided to a receiver of the transceiver that down-converts the RF signal into a baseband signal that is provided to the baseband processor of the processors 1504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1550.

In various embodiments, the RF interface circuitry 1508 may be configured to transmit/receive signals in a manner compatible with NR access technologies.

The antenna 1550 may include a number of antenna elements that each convert electrical signals into radio waves to travel through the air and to convert received radio waves into electrical signals. The antenna elements may be arranged into one or more antenna panels. The antenna 1550 may have antenna panels that are omnidirectional, directional, or a combination thereof to enable beamforming and multiple input, multiple output communications. The antenna 1550 may include microstrip antennas, printed antennas fabricated on the surface of one or more printed circuit boards, patch antennas, phased array antennas, etc. The antenna 1550 may have one or more panels designed for specific frequency bands including bands in FR1 or FR2.

The user interface circuitry 1516 includes various input/output (I/O) devices designed to enable user interaction with the ULE 1500. The user interface 1516 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs), or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1500.

The sensors 1520 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1522 may include software and hardware elements that operate to control particular devices that are embedded in the UE 1500, attached to the UE 1500, or otherwise communicatively coupled with the UE 1500. The driver circuitry 1522 may include individual drivers allowing other components to interact with or control various input/output (I/O) devices that may be present within, or connected to, the UE 1500. For example, driver circuitry 1522 may include a display driver to control and allow access to a display device, a touchscreen driver to control and allow access to a touchscreen interface, sensor drivers to obtain sensor readings of sensor circuitry 1520 and control and allow access to sensor circuitry 1520, drivers to obtain actuator positions of electro-mechanic components or control and allow access to the electro-mechanic components, a camera driver to control and allow access to an embedded image capture device, audio drivers to control and allow access to one or more audio devices.

The PMIC 1524 may manage power provided to various components of the UE 1500. In particular, with respect to the processors 1504, the PMIC 1524 may control power-source selection, voltage scaling, battery charging, or DC-to-DC conversion.

In some embodiments, the PMIC 1524 may control, or otherwise be part of, various power saving mechanisms of the UE 1500. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1500 may power down for brief intervals of time and thus save power. If there is no data traffic activity for an extended period of time, then the UE 1500 may transition off to an RRC_Idle state, where it disconnects from the network and does not perform operations, such as channel quality feedback, handover, etc. The UE 1500 goes into a very low power state and wakes up to listen to paging from the network and then powers down again. The UE 1500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely or shut down RF activity completely. Any data sent during this time incurs a large delay and it is assumed the delay is acceptable.

A battery 1528 may power the UE 1500, although in some examples the UE 1500 may be mounted deployed in a fixed location and may have a power supply coupled to an electrical grid. The battery 1528 may be a lithium-ion battery, a metal-air battery, such as a zinc-air battery, an aluminum-air battery, a lithium-air battery, and the like. In some implementations, such as in vehicle-based applications, the battery 1528 may be a typical lead-acid automotive battery.

FIG. 14 illustrates a gNB 1600, in accordance with some embodiments. The gNB 1600 may be similar to and substantially interchangeable with the gNB 108 of FIG. 1.

The gNB 1600 may include processors 1604, RAN interface circuitry 1608, core network (CN) interface circuitry 1612, and memory/storage circuitry 1616.

The components of the gNB 1600 may be coupled with various other components over one or more interconnects 1628.

The processors 1604, RAN interface circuitry 1608, memory/storage circuitry 1616 (including communication protocol stack 1610), antenna 1650, and interconnects 1628 may be similar to like-named elements shown and described with respect to FIG. 15.

The CN interface circuitry 1612 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1600 via a fiber optic or wireless backhaul. The CN interface circuitry 1612 may include one or more dedicated processors or FPGAs to communicate using one or more of the aforementioned protocols. In some implementations, the CN interface circuitry 1612 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes method implemented by a user equipment (UE), the method comprising: exchanging, with a control plane function of a network, capability information indicating a supported type of data transfer for coverage data, the coverage data indicating at least one of location or timing of a network coverage by a non-terrestrial network (NTN) node of the network; receiving, by using the supported type of data transfer, the coverage data; and communicating with the NTN node based on the coverage data. In an illustrative use case, the method is implemented by a component of the UE, such as by a processor(s) thereof (e.g., the processors 1504), where the component includes processing circuitry and interface circuitry coupled with the processing circuitry, the interface circuitry configured to communicatively couple the processing circuitry with another component of the apparatus. In this case, the processing circuitry is configured to cause an exchange of capability information with a control plane function of a network, the capability information indicating a supported type of data transfer for coverage data, the coverage data indicating at least one of location or timing of a network coverage by a non-terrestrial network (NTN) node of the network; process, by using the supported type of data transfer, the coverage data; and cause communication with the NTN node based on the coverage data. Accordingly, the method in this illustrative use case includes causing an exchange of capability information with a control plane function of a network, the capability information indicating a supported type of data transfer for coverage data, the coverage data indicating at least one of location or timing of a network coverage by a non-terrestrial network (NTN) node of the network; processing, by using the supported type of data transfer, the coverage data; and causing communication with the NTN node based on the coverage data.

Example 2 includes the method of example 1, wherein exchanging the capability information comprises sending the capability information to the control plane function, wherein the capability information indicates one or more data transfer types that the UE supports, and wherein the method further comprises: receiving, from the control plane function, selection information indicating a selection of the supported type of data transfer from the one or more data transfer types.

Example 3 includes the method of example 1, wherein exchanging the capability information comprises receiving the capability information from the control plane function, wherein the capability information indicates one or more data transfer types that the network supports, and wherein the method further comprises: selecting the supported type of data transfer from the one or more data transfer types.

Example 4 includes the method of any of the preceding examples, wherein the capability information indicates that the UE supports at least one of a control plane or a user plane for receiving the coverage data from the network.

Example 5 includes the method of any of the preceding examples, wherein the capability information that the network supports at least one of a control plane or a user plane for sending the coverage data to the UE.

Example 6 includes the method of any of the preceding examples, wherein the supported type of data transfer corresponds to a control plane, and wherein the coverage data is received from the control plane function by at least using the control plane.

Example 7 includes the method of example 6, wherein the control plane function includes a mobility management entity or an access and mobility management function.

Example 8 includes the method of example 6, wherein the coverage data is received by a non-access stratum (NAS) layer of the UE.

Example 9 includes the method of example 8, wherein the coverage data is received in multiple portions based on a control plane protocol other than a NAS protocol.

Example 10 includes the method of example 6, wherein the coverage data is transferred using a non-IP based mechanism.

Example 11 includes the method of example 6, wherein the capability information is sent in a REGISTRATION REQUEST message, and wherein the coverage data is received in a REGISTRATION ACCEPT message.

Example 12 includes the method of example 6, wherein the coverage data is received in a configuration update command message.

Example 13 includes the method of example 6, wherein the coverage data is received in a message associated with a container type for transferring NTN node network coverage.

Example 14 includes the method of example 13, wherein the message includes a downlink NAS transport message that is received based on an uplink NAS transport message sent from the UE.

Example 15 includes the method of example 13, wherein the message includes a command message indicating a procedure transaction identity, a first message identity, and the container type, and wherein the method further comprises: sending, to the control plane function, a completion message indicating the procedure transaction identity and a second message identity.

Example 16 includes the method of example 6, wherein the coverage data is received in an attach accept message or a tracking area update accept message.

Example 17 includes the method of example 1, wherein the supported type of data transfer corresponds to a user plane, and wherein the coverage data is received from an endpoint by at least using the user plane.

Example 18 includes the method of example 17, further comprising: receiving, from the control plane function, an address of the endpoint and a token; and sending, based on the address, a request for the coverage data and the token to the endpoint.

Example 19 includes the method of example 17, further comprising: determining, from a universal subscriber identity module, configuration information of the endpoint; and sending, based on the configuration information, a request for the coverage data.

Example 20 includes the method of example 1, wherein the supported type of data transfer corresponds to a short message service (SMS), and wherein the coverage data is received, from an endpoint, in an SMS response or a concatenated SMS response.

Example 21 includes the method of example 20, further comprising: receiving, from the control plane function, an address of the endpoint and a token; and sending, based on the address, an SMS query for the coverage data and the token to the endpoint.

Example 22 includes the method of example 1, wherein the coverage data is received from the control plane function based on a transfer of the coverage data from an operation and maintenance server of the network to the control plane function.

Example 23 is a method implemented by a network, the method comprising: exchanging, by a control plane function of the network, capability information with a user equipment (UE), the capability information indicating a supported type of data transfer for coverage data, the coverage data indicating at least one of location or timing of a network coverage by a non-terrestrial network (NTN) node of the network; and causing the coverage data to be sent to the UE based on the supported type of data transfer, wherein communication between the UE and the NTN node is facilitated based on the coverage data.

Example 24 includes the method of example 23, wherein the supported type of data transfer corresponds to a control plane, and wherein the coverage data is sent by the control plane function by at least using the control plane or a non-IP based delivery mechanism.

Example 25 includes the method of example 23, wherein the supported type of data transfer corresponds to a user plane, and wherein the method further comprises: sending, by the control plane function to the UE, an address of an endpoint and a token, the endpoint storing the coverage data.

Example 26 includes the method of example 23, wherein the supported type of data transfer corresponds to a short message service (SMS), and wherein the method further comprises: sending, by the control plane function to the UE, an address of an endpoint and a token, the endpoint storing the coverage data.

Example 27 includes the method of example 23, wherein the coverage data is sent by the control plane function based on a transfer of the coverage data from an operation and maintenance server of the network to the control plane function.

Example 28 includes the method of example 23, wherein the coverage data is sent in a system information block (SIB) broadcast.

Example 29 includes a device comprising means to perform one or more elements of a method described in or related to any of the examples 1-28.

Example 30 includes one or more non-transitory computer-readable media comprising instructions to cause a device, upon execution of the instructions by one or more processors of the device, to perform one or more elements of a method described in or related to any of the examples 1-28.

Example 31 includes a device comprising logic, modules, or circuitry to perform one or more elements of a method described in or related to any of the examples 1-28.

Example 32 includes a device comprising: one or more processors and one or more computer-readable media comprising instructions that, when executed by the one or more processors, cause the one or more processors to perform one or more elements of a method described in or related to any of the examples 1-28.

Example 33 includes a system comprising means to perform one or more elements of a method described in or related to any of the examples 1-28.

Example 34 includes a network comprising means to perform one or more elements of a method described in or related to any of the examples 1-28.

Example 35 includes one or more non-transitory computer-readable media comprising instructions to cause a network, upon execution of the instructions by one or more processors of the network, to perform one or more elements of a method described in or related to any of the examples 1-28.

Example 36 includes a network comprising logic, modules, or circuitry to perform one or more elements of a method described in or related to any of the examples 1-28.

Example 37 includes a network comprising: one or more processors and one or more computer-readable media comprising instructions that, when executed by the one or more processors, cause the one or more processors to perform one or more elements of a method described in or related to any of the examples 1-28.

Example 38 includes a component to be implemented in an apparatus (where the apparatus can be any of the apparatuses described herein above such as a UE, a network, or a network node), the component comprising: processing circuitry configured to perform one or more elements of a method described in or related to any of the examples 1-28, and interface circuitry coupled with the processing circuitry, the interface circuitry configured to communicatively couple the processing circuitry with another component of the apparatus.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A method implemented by a user equipment (UE), the method comprising:
causing an exchange of capability information with a control plane function of a network, the capability information indicating a supported type of data transfer for coverage data, the coverage data indicating at least one of location or timing of a network coverage by a non-terrestrial network (NTN) node of the network;
processing, by using the supported type of data transfer, the coverage data; and
causing communication with the NTN node based on the coverage data.

2. The method of claim 1, wherein causing the exchange comprises causing the capability information to be sent to the control plane function, wherein the capability information indicates one or more data transfer types that the UE supports, and wherein the method further comprises:
processing selection information that is received from the control plane function and that indicates a selection of the supported type of data transfer from the one or more data transfer types.

3. The method of claim 1, wherein causing the exchange comprises causing the capability information to be received from the control plane function, wherein the capability information indicates one or more data transfer types that the network supports, and wherein the method further comprises:
selecting the supported type of data transfer from the one or more data transfer types.

4. The method of claim 1, wherein the capability information indicates that the UE supports at least one of a control plane or a user plane for receiving the coverage data from the network.

5. The method of claim 1, wherein the capability information indicates that the network supports at least one of a control plane or a user plane for sending the coverage data to the UE.

6. The method of claim 1, wherein the supported type of data transfer corresponds to a control plane, wherein the coverage data is received from the control plane function by at least using the control plane, and wherein the control plane function includes a mobility management entity or an access and mobility management function.

7. The method of claim 6, wherein the coverage data is received by a non-access stratum (NAS) layer of the UE, wherein the coverage data is received in multiple portions based on a control plane protocol other than a NAS protocol.

8. The method of claim 6, wherein the coverage data is transferred using a non-IP based mechanism or is received in a configuration update command message, an attach accept message, or a tracking area update accept message, and wherein the capability information is sent in a REGISTRATION REQUEST message, and wherein the coverage data is received in a REGISTRATION ACCEPT message.

9. The method of claim 6, wherein the coverage data is received in a message associated with a container type for transferring NTN node network coverage, wherein the message includes a downlink NAS transport message that is received based on an uplink NAS transport message sent from the UE.

10. The method of claim 6, wherein the coverage data is received in a message associated with a container type for transferring NTN node network coverage, wherein the message includes a command message indicating a procedure transaction identity, a first message identity, and the container type, and wherein the method further comprises:
causing a completion message to be sent to the control plane function, the completion message indicating the procedure transaction identity and a second message identity.

11. A component to be implemented in an apparatus, the component comprising:
processing circuitry configured to:
cause an exchange of capability information with a control plane function of a network, the capability information indicating a supported type of data transfer for coverage data, the coverage data indicating at least one of location or timing of a network coverage by a non-terrestrial network (NTN) node of the network;
process, by using the supported type of data transfer, the coverage data; and
cause communication with the NTN node based on the coverage data; and
interface circuitry coupled with the processing circuitry, the interface circuitry configured to communicatively couple the processing circuitry with another component of the apparatus.

12. The component of claim 11, wherein the supported type of data transfer corresponds to a user plane, and wherein the coverage data is received from an endpoint by at least using the user plane, wherein the processing circuitry is further configured to:
process an address of the endpoint and a token received from the control plane function; and
cause, based on the address, a request for the coverage data and the token to be sent to the endpoint.

13. The component of claim 11, wherein the supported type of data transfer corresponds to a user plane, and wherein the coverage data is received from an endpoint by at least using the user plane, wherein the processing circuitry is further configured to:
determine, from a universal subscriber identity module, configuration information of the endpoint; and
cause, based on the configuration information, a request for the coverage data to be sent.

14. The component of claim 11, wherein the supported type of data transfer corresponds to a short message service (SMS), and wherein the coverage data is received, from an endpoint, in an SMS response or a concatenated SMS response, and wherein the processing circuitry is further configured to:
process an address of the endpoint and a token received from the control plane function; and
cause, based on the address, an SMS query for the coverage data and the token be sent to the endpoint.

15. The component of claim 11, wherein the coverage data is received from the control plane function based on a transfer of the coverage data from an operation and maintenance server of the network to the control plane function.

16. A network comprising:
one or more processors; and
one or more memory storing instructions that, upon execution by the one or more processors, configure the network to:
exchange, by a control plane function of the network, capability information with a user equipment (UE), the capability information indicating a supported type of data transfer for coverage data, the coverage data indicating at least one of location or timing of a network coverage by a non-terrestrial network (NTN) node of the network; and
cause the coverage data to be sent to the UE based on the supported type of data transfer, wherein communication between the UE and the NTN node is facilitated based on the coverage data.

17. The network of claim 16, wherein the supported type of data transfer corresponds to a control plane, and wherein the coverage data is sent by the control plane function by at least using the control plane or a non-IP based delivery mechanism.

18. The network of claim 16, wherein the supported type of data transfer corresponds to a user plane, and wherein the one or more memory store further instructions that, upon execution by the one or more processors, configure the network to:
send, by the control plane function to the UE, an address of an endpoint and a token, the endpoint storing the coverage data.

19. The network of claim 16, wherein the supported type of data transfer corresponds to a short message service (SMS), and wherein the one or more memory store further instructions that, upon execution by the one or more processors, configure the network to:
send, by the control plane function to the UE, an address of an endpoint and a token, the endpoint storing the coverage data.

20. The network of claim 16, wherein the coverage data is sent by the control plane function based on a transfer of the coverage data from an operation and maintenance server of the network to the control plane function or in a system information block (SIB) broadcast.
